(19) United States
(12) Patent Application Publication
(10) Pub. No.: US 2025/0005871 A1
(43) Pub. Date: Jan. 2, 2025

(54) CREATING A DYNAMIC AUGMENTED REALITY-BASED SESSION FOR COMMUNICATION AND COLLABORATION

(71) Applicant: INTERNATIONAL BUSINESS MACHINES CORPORATION, ARMONK, NY (US)

(72) Inventors: Jeremy R. Fox, Georgetown, TX (US); Randy R. Rendahl, Raleigh, NC (US); Tushar Agrawal, West Fargo, ND (US); Sarbajit K. Rakshit, Kolkata (IN)

(21) Appl. No.: 18/341,826

(22) Filed: Jun. 27, 2023

(51) Int. Cl. G06T 19/00; G06Q 10/0631; G06Q 10/0633

(52) U.S. Cl. CPC G06T 19/006; G06Q 10/063114; G06Q 10/0633; G06T 2219/024

(57) ABSTRACT

An approach is provided for creating a dynamic augmented reality (AR)-based communication and collaboration session. A workflow involving multiple users and activities of the workflow are analyzed based on a current context, service level agreements established for the activities, permissions of the multiple users related to completing certain activities, hardware required to complete the activities, and capabilities of the hardware. Based on the analyzed workflow, an AR-based session is proactively established among the multiple users. Communication and collaboration are established among the multiple users based on the AR-based session. The communication and collaboration are established as the multiple users are performing respective activities within the workflow.

### BACKGROUND

The present invention relates to augmented reality-based communication, and more particularly to establishing communication and collaboration between participants in a workflow by using augmented reality.

As users work through activities in a workflow, the users need a way to communicate and collaborate with each other. Traditional ways of communicating require the users to be connected via software-based collaboration tools or device-to-device paired communication.

### SUMMARY

In one embodiment, the present invention provides a computer system that includes one or more computer processors, one or more computer readable storage media, and computer readable code stored collectively in the one or more computer readable storage media. The computer readable code includes data and instructions to cause the one or more computer processors to perform operations. The operations include analyzing (i) a workflow that involves multiple users and (ii) activities of the workflow based on a current context, service level agreements (SLAs) established for the activities, permissions of the multiple users related to completing certain activities, hardware required to complete the activities, and capabilities of the hardware. The operations further include, based on the analyzed workflow, proactively establishing an augmented reality (AR)-based session among the multiple users. The operations further include establishing communication and collaboration among the multiple users based on the AR-based session. The communication and collaboration are established as the multiple users are performing respective activities within the workflow.

A computer program product and a method corresponding to the above-summarized computer system are also described and claimed herein.

### BRIEF DESCRIPTION OF THE DRAWINGS

FIG. 1 is a block diagram of a system for creating a dynamic augmented reality-based session for communication and collaboration among participants in a workflow, in accordance with embodiments of the present invention.

FIG. 2 is a block diagram of modules included in code included in the system of FIG. 1, in accordance with embodiments of the present invention.

FIG. 3 is a flowchart of a process of creating a dynamic augmented reality-based session for communication and collaboration among participants in a workflow, where the operations of the flowchart are performed by the modules in FIG. 2, in accordance with embodiments of the present invention.

FIG. 4 is a block diagram of a system for context analysis and AR-based session creation, which includes the system of FIG. 1 and which implements the process of FIG. 3, in accordance with embodiments of the present invention.

FIG. 5 is an example of a use case that employs the system of FIG. 4, in accordance with embodiments of the present invention.

### DETAILED DESCRIPTION

### Overview

As multiple users perform one or more tasks within a workflow, the users employ conventional communication and collaboration techniques in ways that are inefficient or ineffective at attaining a goal. Initiating the conventional communication and collaboration techniques within a workflow may be delayed because the workflow relies too heavily on manual or reactive efforts, which leads to further inefficiencies and delays in completing steps within the workflow.

Embodiments of the present invention address the aforementioned unique challenges by providing a dynamic augmented reality (AR)-based session for communication and collaboration through infused workflow amelioration. A system providing the aforementioned dynamic AR-based session analyzes a workflow and the activities involved in the workflow based on a current context and a consideration of service level agreements (SLAs) established for the activities, permissions of the users who are completing the activities, the hardware (i.e., devices and equipment) involved in completing the activities, and the capabilities of the hardware. In one embodiment, the system disclosed herein learns behaviors and skills of users over a period of time and uses the learning to proactively establish the AR-based session for communication and collaboration among the users. As used herein, users are defined as participants involved in completing steps (i.e., tasks) within a workflow.

In one embodiment, the system disclosed herein providing the dynamic AR-based session for communication and collaboration is incorporated into known workflow integration software to improve the functionality of the workflow integration software.

Although embodiments described herein create an AR-based session, alternate embodiments are contemplated that replace AR with virtual reality (VR) and create a VR-based session for communication and collaboration among users in a workflow.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

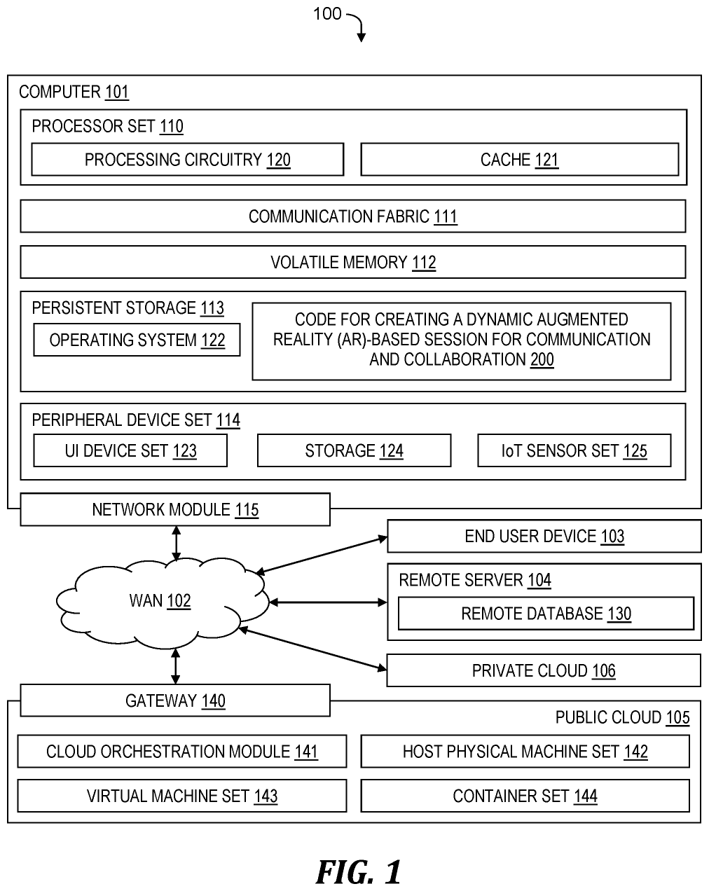

FIG. 1 is a block diagram of a system for creating a dynamic augmented reality-based session for communication and collaboration among participants in a workflow, in accordance with embodiments of the present invention. Computing environment 100 contains an example of an environment for the execution of at least some of the computer code involved in performing the inventive methods, such as code 200 for creating a dynamic AR-based session for communication and collaboration among users in a workflow by using infused workflow amelioration. The aforementioned computer code is also referred to herein as computer readable code, computer readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### System and Process for Creating a Dynamic AR-Based Session for Communication and Collaboration

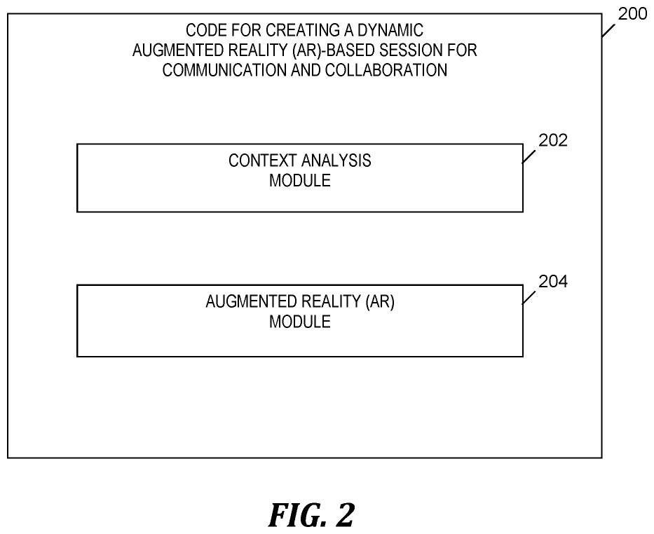

FIG. 2 is a block diagram of modules included in code 200 included in system 100 of FIG. 1, in accordance with embodiments of the present invention. Code 200 includes a context analysis module 202 and an AR module 204. Context analysis module 202 is configured to analyze a workflow and activities involved in the workflow based on a current context of the workflow, SLAs established for the activities of the workflow, permissions of users to complete certain activities of the workflow, hardware (i.e., devices and equipment) involved in the activities of the workflow, and the capabilities of the hardware. A current context of a workflow includes the step that is currently being performed in the workflow, one or more steps, if any, being performed in parallel with the step currently being performed, a specification of the communication and collaboration requirements of the step, an identification of the particular users who are involved in completing the step or any other step(s) being performed in parallel with the step, and an identification of the user(s) to whom the process of the workflow is handed after the step is completed.

Context analysis module 202 uses a workflow model language to define a workflow model, which includes the steps to be completed in the workflow, the actors (i.e., users) used to complete the steps, and a specification of the communication and collaboration required across the actors. Context analysis module 202 reviews the workflow model to identify the communication and collaboration requirements, which include (i) the points in the flow that are held up in the absence of communication; (ii) the points in the flow that information is produced which allows communication; and (iii) the communications that are optional.

In one embodiment, context analysis module 202 receives workflow identifications from a user, which identify each unique instance of the workflow when the instance is active. For example, the workflow identifications can include a manufacturing line identity, a trouble ticket number, and a patent disclosure number.

In one embodiment, context analysis module 202 defines rules that specify an assignment of individuals (i.e., users) to roles that will be realized in each workflow instance. The rules state where in the flow a role of a user is identified and how a user in that role is added to system 100. For example, the rules can indicate that some employees do not need to opt into a collaboration support provided by system 100 or require a collection of new contact information, while customers or other participants in the workflow require a more complete onboarding with the context of the workflow instance. Hereinafter, system 100 is also referred to as the AR system.

In one embodiment, context analysis module 202 defines rules that are related to a visibility to workflow steps based on the role of a participant in the workflow. Using these rules, AR module 204 notifies a user that a particular step is beginning or being completed in response to the user having been registered to have an interest in the status of that particular step or in response to a default procedure.

Context analysis module 202 may customize the method and style of information sharing among participants in the workflow to provide a brand or ensure that the workflow participants experience a consistent feel during the AR-based session.

AR module 204 detects that a user initiates an instance of the workflow by taking the first step in the workflow and opting into the collaboration support provided by system 100. In one embodiment, AR module 204 registers the user with information that enables system 100 to engage directly with the user if the user is currently in the AR-based session or solicit the user to enter the AR-based session if the user is not currently in the AR-based session.

As part of the AR experience, AR module 204 presents the user with descriptions of any involvement in one or more activities that is available to the user in the current workflow. In a case in which the user needs to complete a step of the workflow, the AR-based session provides a visibility to any information that has been collected and is needed within the step.

In a case in which the user is a source of information, either from a completed workflow step or as organic information, AR module 204 provides an AR interface to the user to share the information of which the user is the source or to review the information provided with the workflow.

For a user who is participating in multiple workflow instances, AR module 204 presents a summary of workflow instance activities in which the user is currently involved in performing. AR module 204 also provides the user with an ability to specify and act on an individual workflow instance from among the multiple workflow instances. In one embodiment, AR module 204 presents the user with highlighted identifications of workflow instances that are currently waiting for input from, an action by, or attention by the user, along with summaries of the highlighted workflow instances.

As a given step in the workflow begins, AR module 204 notifies the participants who have expressed an interest in the status of the given step. In one embodiment, AR module 204 allows users to gather in the AR-based session with the owner of the given step, thereby allowing discussion among the users and the owner, and sharing of an access to the given step. In one embodiment, a user may also provide alternate responses that indicate non-participation or non-interest in the AR-based session, the user is delayed but will be joining the AR-based session, the user is not joining unless the user is summoned, etc., where the responses are denoted in the AR environment for the given step.

As each step in the workflow is completed, AR module 204 updates the dashboards in the AR interfaces provided to the users in the workflow. In one embodiment, AR module 204 adds new dependent tasks in the backlogs of the participants. In one embodiment, AR module 204 provides new data to be reviewed by the producer or the consumer of the data. In one embodiment, AR module 204 identifies new participants in the workflow and notifies the new participants about the workflow instance according to the rules defined by context analysis module 202 during an analysis of the workflow.

Throughout the process of creating a dynamic AR-based session for communication and collaboration among users in the workflow, participants in the workflow may provide feedback on the experience to allow improvements to be made and incorporated by AR module 204. In one embodiment, AR module 204 uses an artificial intelligence (AI) system to provide updates or recommendations to make the improvements. In another embodiment, a human tweaks the work done in the model analysis to achieve the improvement.

In response to a completion of a workflow instance, AR module 204 archives the workflow instance so that the participants of the workflow retain pertinent information to reflect the work completed and to respond to questions or issues related to the work completed.

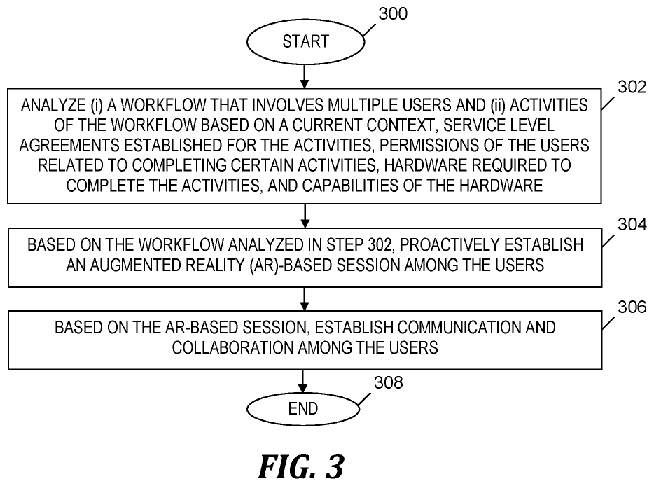

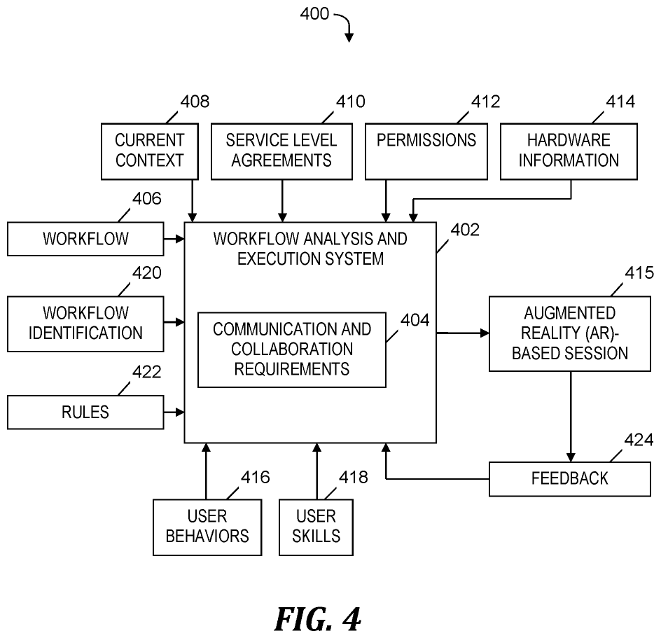

The functionality of the modules included in code 200 is further discussed below relative to FIG. 3 and FIG. 4.

FIG. 3 is a flowchart of a process of creating a dynamic augmented reality-based session for communication and collaboration among participants in a workflow, where the operations of the flowchart are performed by the modules in FIG. 2, in accordance with embodiments of the present invention. The process of FIG. 3 begins at a start node 300. In step 302, context analysis module 202 analyzes (i) a workflow that involves multiple users and (ii) activities of the workflow, where the analysis of the aforementioned workflow and activities is based on a current context, SLAs established for the activities, permissions of the users related to completing certain activities of the workflow, hardware required to complete the activities of the workflow, and capabilities of the hardware. In one embodiment, the hardware includes computing devices and equipment involved in the activities of the workflow.

In step 304, AR module 204, based on the analyzing performed in step 302, proactively establishes an AR-based session among the users as the users are working on respective activities within the workflow. The establishment of the AR-based session in step 304 enables communication and collaboration among the users as the users perform activities within the workflow. In step 304, AR-module 204 also provides an AR interface to AR devices being utilized by the users in the workflow so that the users can interact in the AR-based session. As used herein, an AR device is a device that allows a user to view and interact with AR and includes, for example, AR glasses, an AR headset, or an AR display.

In step 306, AR module 204, based on the AR-based session established in step 304, establishes communication and collaboration among the users in the workflow.

Following step 306, the process of FIG. 3 ends at an end node 308.

In one embodiment, the process of FIG. 3 further includes AR module 204 (i) learning behaviors of the users and skills of the users over a period of time and (ii) based on the learned behaviors and skills, determining a time during the execution of the workflow at which the AR-based session is needed, so that the proactive establishment of the AR-based session in step 304 is performed at the aforementioned time during the execution of the workflow.

In one embodiment, the process of FIG. 3 further includes AR module 204 (i) registering a user to allow the AR system to engage the user while the user is currently in the AR-based session or solicit an entrance of the user into the AR-based session if the user is not currently in the AR-based session; (ii) initiating an instance of the workflow by determining that the user performs a first step in the workflow and the user opts into a collaboration support provided by the AR system via the AR-based session; (iii) determining that the user is currently included in the AR-based session; and (iv) based on the user being currently included in the AR-based session, the AR system directly engaging the user within the AR-based session.

In one embodiment, the process of FIG. 3 further includes AR module 204 performing (i) and (ii) as described in the immediately preceding paragraph; (iii) determining that the user is not currently included in the AR-based session; and (iv) based on the user being not currently included in the AR-based session, the AR system soliciting the user to enter the AR-based session.

In one embodiment, the process of FIG. 3 further includes (i) context analysis module 202 receiving workflow details in a workflow model language, where the workflow details include steps in the workflow that need to be completed, actors who need to complete the steps, and a specification of communication required among the actors to complete the steps; (ii) context analysis module 202 collecting information needed to complete a step included in the steps in the workflow; (iii) AR module 204, based on the received workflow details, determining that a user needs to complete the step in the workflow; and (iv) AR module 204, based on the user needing to complete the step in the workflow, providing the user with a visibility to the collected information via an AR interface presented by an AR device utilized by the user.

In one embodiment, the process of FIG. 3 further includes AR module 204 (i) determining that a user is a source of information needed to complete a step in the workflow; (ii) based on the user being the source of the information, providing an AR interface to an AR device being utilized by the user, where the AR interface is configured to share information with one or more other users; and (iii) sharing the information with one or more other users via the AR interface.

In one embodiment, the process of FIG. 3 further includes AR module 204 (i) providing an AR interface to a user during the AR-based session; (ii) determining that the user is participating in multiple workflow instances; and (iii) based on the user participating in the multiple workflow instances, displaying, in the AR interface, a summary of tasks for which the user is currently responsible for completing in the multiple workflow instances and highlighting, in the AR interface, one or more workflow instances included in the multiple workflow instances that are waiting on an input from the user, an action by the user, or an attention by the user.

In one embodiment, the process of FIG. 3 further includes AR module 204 (i) registering a user as having an interest in a status of a step of the workflow, where the status indicates the step is beginning or the step is being completed; (ii) determining a role of the user; (iii) receiving or defining rules specifying a visibility of the step to the user based on the role of the user; and (iv) based on the user having the interest in the status of the step, the role of the user, and the rules specifying the visibility of the step to the user, notifying the user about the step beginning or being completed.

In one embodiment, the process of FIG. 3 further includes AR module 204 gathering the user and an owner of the step of the workflow in the AR-based session for a discussion between the user and the owner about the step or a sharing of an access to the step (i.e., the owner sharing the access with the user).

FIG. 4 is a block diagram of a system 400 for context analysis and AR-based session creation, which includes the system of FIG. 1 and which implements the process of FIG. 3, in accordance with embodiments of the present invention. System 400 includes a software-based workflow analysis and execution system 402, which generates communication and collaboration requirements 404. In one embodiment, workflow analysis and execution system 402 includes context analysis module 202 (see FIG. 2) and AR module 204 (see FIG. 2). Workflow analysis and execution system 402 receives a workflow 406, determines a current context 408 of the workflow 406, and receives service level agreements 410 established for the activities of workflow 406, permissions 412 of the users to complete certain activities of workflow 406, and hardware information 414, which includes (i) an identification of the devices and equipment required to compete the activities of workflow 406 and (ii) the capabilities of the devices and equipment.

Workflow analysis and execution system 402 determines user behaviors 416 and user skills 418. Workflow analysis and execution system 402 further receives workflow identification 420 and rules 422. Workflow identification 420 identifies a unique instance of workflow 406, and may include descriptions such as, for example, manufacturing line identity or trouble ticket number. Rules 422 include rules for assigning participants of workflow 406 to roles that are realized in each instance of workflow 406 and include other rules for providing visibility to steps of workflow 406 based on a role assigned to a participant of workflow 406. In one or more embodiments, workflow analysis and execution system 402 utilizes workflow identification 420 and rules 422 as described above relative to the discussion of FIG. 2.

Workflow analysis and execution system 402 analyzes workflow 406 and activities of workflow 406, where the analysis is based on current context 408, service level agreements 410, permissions 412, and hardware information 414. Based on the analysis of workflow 406 and the activities of workflow 406, workflow analysis and execution system 402 proactively establishes an AR-based session 415 among participants in workflow 406.

In one embodiment, workflow analysis and execution system 402, over a period of time, learns user behaviors 416 (i.e., behaviors of participants in workflow 406) and learns user skills 418 (i.e., skills of participants in workflow 406). In one embodiment, the aforementioned proactive establishment of the AR-based session 415 is further based on the learned user behaviors 416 and user skills 418.

Participants in the AR-based session 415 provide feedback 424 on the experience of working on activities of workflow 406 and communicating and collaborating with other participants in AR-based session 415. AR-based session 415 sends the feedback to workflow analysis and execution system 402, which uses the feedback to generate improvements to communication and collaboration among participants in workflow 406 via a subsequent AR-based session.

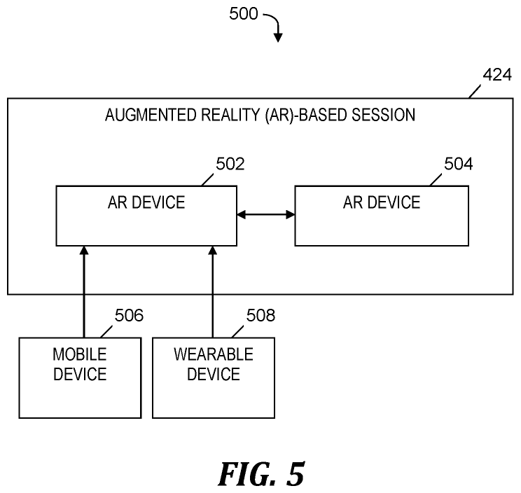

FIG. 5 is an example 500 of a use case that employs the system of FIG. 4, in accordance with embodiments of the present invention. Example 500 includes AR-based session 424, which includes an AR device 502 capable of interacting with an AR device 504, where AR device 502 is utilized by a cook in a restaurant and AR device 504 is utilized by a customer of the restaurant. In response to the customer ordering food in the restaurant, the cook receives the food order. While the cook is preparing the food ordered by the customer, the cook and the customer interact with each other within AR-based session 424 by using AR device 502 and AR device 504, respectively, where the interaction includes the customer requesting a customization of the food order. The cook also receives feeds from a mobile device 506 and a wearable device 508, which are operated by the customer. The customer has integrated mobile device 506 and wearable device 508 with the AR-based session 424.

As a further example, AR-based session 424 is a session between the customer, the spouse of the customer, the cook, and the server, which facilitates a specific type of delivery of food to a table at which the customer and the customer's spouse are seated; e.g., for a delivery of food for a surprise birthday celebration, the customer's spouse does not have permission to see the delivery process of certain food (because the certain food is supposed to be a birthday surprise to the customer's spouse), but is allowed to participate in the customization of the preparation of other food.

The descriptions of the various embodiments of the present invention have been presented herein for purposes of illustration but are not intended to be exhaustive or limited to the embodiments disclosed. Many modifications and variations will be apparent to those skilled in the art. Accordingly, the appended claims are intended to encompass all such modifications and variations as fall within the true spirit and scope of the embodiments described herein.

What is claimed is:

1. A computer system comprising:
one or more computer processors;
one or more computer readable storage media; and
computer readable code stored collectively in the one or more computer readable storage media, with the computer readable code including data and instructions to cause the one or more computer processors to perform at least the following operations:
analyzing a workflow that involves multiple users and activities of the workflow based on a current context, service level agreements (SLAs) established for the activities, permissions of the multiple users related to completing certain activities, hardware required to complete the activities, and capabilities of the hardware;
based on the analyzed workflow, proactively establishing an augmented reality (AR)-based session among the multiple users; and
establishing communication and collaboration among the multiple users based on the AR-based session, the communication and collaboration being established as the multiple users are performing respective activities within the workflow.

2. The computer system of claim 1, wherein the computer readable code including the data and the instructions causes the one or more computer processors to perform the following further operations:
learning behaviors and skills of the multiple users over a period of time; and
based on the learned behaviors and skills, determining a time during the workflow at which the AR-based session is needed, wherein the proactively establishing the AR-based session is performed at the time.

3. The computer system of claim 1, wherein the computer system further comprises an AR system, and wherein the computer readable code including the data and the instructions causes the one or more computer processors to perform the following further operations:
registering a user to allow the AR system to engage the user while the user is in the AR-based session or solicit an entrance of the user into the AR-based session;
initiating an instance of the workflow by determining that the user performs a first step in the workflow and the user opts into a collaboration support provided by the AR system via the AR-based session;
determining that the user is currently included in the AR-based session; and
based on the user being currently included in the AR-based session, the AR system directly engaging the user within the AR-based session.

4. The computer system of claim 1, wherein the computer system further comprises an AR system, and wherein the computer readable code including the data and the instructions causes the one or more computer processors to perform the following further operations:
registering a user to allow the AR system to engage the user while the user is in the AR-based session or solicit an entrance of the user into the AR-based session;
initiating an instance of the workflow by determining that the user performs a first step in the workflow and the user opts into a collaboration support provided by the AR system via the AR-based session;
determining that the user is not currently in the AR-based session; and
based on the user being not currently in the AR-based session, the AR system soliciting the user to enter the AR-based session.

5. The computer system of claim 1, wherein the computer readable code including the data and the instructions causes the one or more computer processors to perform the following further operations:
receiving workflow details in a workflow model language, the workflow details including steps in the workflow that need to be completed, actors who need to complete the steps, and a specification of communication required among the actors to complete the steps;
collecting information needed to complete a step included in the steps in the workflow;
based on the received workflow details, determining that a user needs to complete the step in the workflow; and
based on the user needing to complete the step in the workflow, providing the user with a visibility to the collected information via an AR interface.

6. The computer system of claim 1, wherein the computer readable code including the data and the instructions causes the one or more computer processors to perform the following further operations:
determining that a user is a source of information needed to complete a step in the workflow;
based on the user being the source of the information, providing an AR interface to the user, the AR interface being configured to share the information with one or more other users; and
sharing the information with one or more other users via the AR interface.

7. The computer system of claim 1, wherein the computer readable code including the data and the instructions causes the one or more computer processors to perform the following further operations:
providing an AR interface to a user during the AR-based session;
determining that the user is participating in multiple workflow instances; and
based on the user participating in the multiple workflow instances, displaying, in the AR interface, a summary of tasks for which the user is currently responsible in the multiple workflow instances and highlighting, in the AR interface, one or more workflow instances included in the multiple workflow instances that are waiting on an input from user, an action by the user, or an attention by the user.

8. The computer system of claim 1, wherein the computer readable code including the data and the instructions causes the one or more computer processors to perform the following further operations:
registering a user as having an interest in a status of a step in the workflow, the status indicating that the step is beginning or the step is being completed;
determining a role of the user;
receiving rules specifying a visibility of the step to the user based on the role of the user; and
based on the user having the interest in the status of the step, the role of the user, and the rules specifying the visibility of the step to the user, notifying the user about the step beginning or being completed.

9. The computer system of claim 8, wherein the computer readable code including the data and the instructions causes the one or more computer processors to perform the following further operation:
gathering the user and an owner of the step in the AR-based session for a discussion between the user and the owner about the step or a sharing of an access to the step.

10. A computer program product comprising:
one or more computer readable storage media having computer readable program code collectively stored on the one or more computer readable storage media, the computer readable program code being executed by one or more processors of a computer system to cause the computer system to perform at least the following operations:
analyzing a workflow that involves multiple users and activities of the workflow based on a current context, service level agreements (SLAs) established for the activities, permissions of the multiple users related to completing certain activities, hardware required to complete the activities, and capabilities of the hardware;
based on the analyzed workflow, proactively establishing an augmented reality (AR)-based session among the multiple users; and
establishing communication and collaboration among the multiple users based on the AR-based session, the communication and collaboration being established as the multiple users are performing respective activities within the workflow.

11. The computer program product of claim 10, wherein the computer readable program code being executed by the one or more processors of the computer system causes the computer system to perform the following further operations:
learning behaviors and skills of the multiple users over a period of time; and
based on the learned behaviors and skills, determining a time during the workflow at which the AR-based session is needed, wherein the proactively establishing the AR-based session is performed at the time.

12. The computer program product of claim 10, wherein the computer readable program code being executed by the one or more processors of the computer system causes the computer system to perform the following further operations:
registering a user to allow an AR system included in the computer system to engage the user while the user is in the AR-based session or solicit an entrance of the user into the AR-based session;
initiating an instance of the workflow by determining that the user performs a first step in the workflow and the user opts into a collaboration support provided by the AR system via the AR-based session;
determining that the user is currently included in the AR-based session; and
based on the user being currently included in the AR-based session, the AR system directly engaging the user within the AR-based session.

13. The computer program product of claim 10, wherein the computer readable program code being executed by the one or more processors of the computer system causes the computer system to perform the following further operations:
registering a user to allow an AR system included in the computer system to engage the user while the user is in the AR-based session or solicit an entrance of the user into the AR-based session;
initiating an instance of the workflow by determining that the user performs a first step in the workflow and the user opts into a collaboration support provided by the AR system via the AR-based session;
determining that the user is not currently in the AR-based session; and
based on the user being not currently in the AR-based session, the AR system soliciting the user to enter the AR-based session.

14. The computer program product of claim 10, wherein the computer readable program code being executed by the one or more processors of the computer system causes the computer system to perform the following further operations:
receiving workflow details in a workflow model language, the workflow details including steps in the workflow that need to be completed, actors who need to complete the steps, and a specification of communication required among the actors to complete the steps;
collecting information needed to complete a step included in the steps in the workflow;
based on the received workflow details, determining that a user needs to complete the step in the workflow; and
based on the user needing to complete the step in the workflow, providing the user with a visibility to the collected information via an AR interface.

15. The computer program product of claim 10, wherein the computer readable program code being executed by the one or more processors of the computer system causes the computer system to perform the following further operations:
determining that a user is a source of information needed to complete a step in the workflow;
based on the user being the source of the information, providing an AR interface to the user, the AR interface being configured to share the information with one or more other users; and
sharing the information with one or more other users via the AR interface.

16. A computer-implemented method comprising:
analyzing, by one or more processors, a workflow that involves multiple users and activities of the workflow based on a current context, service level agreements (SLAs) established for the activities, permissions of the multiple users related to completing certain activities, hardware required to complete the activities, and capabilities of the hardware;
based on the analyzed workflow, proactively establishing, by the one or more processors, an augmented reality (AR)-based session among the multiple users; and
establishing, by the one or more processors, communication and collaboration among the multiple users based on the AR-based session, the communication and collaboration being established as the multiple users are performing respective activities within the workflow.

17. The method of claim 16, further comprising:
learning, by the one or more processors, behaviors and skills of the multiple users over a period of time; and
based on the learned behaviors and skills, determining, by the one or more processors, a time during the workflow at which the AR-based session is needed, wherein the proactively establishing the AR-based session is performed at the time.

18. The method of claim 16, further comprising:
registering, by the one or more processors, a user to allow an AR system included in a computer system to engage the user while the user is in the AR-based session or solicit an entrance of the user into the AR-based session;
initiating, by the one or more processors, an instance of the workflow by determining that the user performs a first step in the workflow and the user opts into a collaboration support provided by the AR system via the AR-based session;
determining, by the one or more processors, that the user is currently included in the AR-based session; and
based on the user being currently included in the AR-based session, directly engaging, by the AR system, the user within the AR-based session.

19. The method of claim 16, further comprising:
registering, by the one or more processors, a user to allow an AR system included in a computer system to engage the user while the user is in the AR-based session or solicit an entrance of the user into the AR-based session;
initiating, by the one or more processors, an instance of the workflow by determining that the user performs a first step in the workflow and the user opts into a collaboration support provided by the AR system via the AR-based session;
determining, by the one or more processors, that the user is not currently in the AR-based session; and
based on the user being not currently in the AR-based session, soliciting, by the AR system, the user to enter the AR-based session.

20. The method of claim 16, further comprising:
receiving, by the one or more processors, workflow details in a workflow model language, the workflow details including steps in the workflow that need to be completed, actors who need to complete the steps, and a specification of communication required among the actors to complete the steps;
collecting, by the one or more processors, information needed to complete a step included in the steps in the workflow;
based on the received workflow details, determining, by the one or more processors, that a user needs to complete the step in the workflow; and
based on the user needing to complete the step in the workflow, providing, by the one or more processors, the user with a visibility to the collected information via an AR interface.
